(19) United States
(12) Patent Application Publication
(10) Pub. No.: US 2012/0078979 A1
(43) Pub. Date: Mar. 29, 2012

(54) Method for advanced patent search and analysis

(76) Inventor: Shankar Raj Ghimire, Fairfax, VA (US)

(21) Appl. No.: 13/136,229

(22) Filed: Jul. 26, 2011

Related U.S. Application Data
(60) Provisional application No. 61/367,453, filed on Jul. 26, 2010.

(51) Int. Cl. G06F 17/30

(52) U.S. Cl. 707/805; 707/E17.03

(57) ABSTRACT

Methods, programs products and systems are provided for improved techniques for enabling a search engine user to quickly and effectively analyze a patent and non-patent document by analyzing and parsing the user's inputted query and presenting a plurality of keywords set in accordance with a user's search feature to the end user which can be used to analyze the result in a more focused and efficient way. According to one of the preferred embodiments, the inventive program code of the system automatically categorizes the user's search strings (having multiple strings representative of multiple search features) and displays multiple keyword sets wherein each keyword set represents the individual search features after the execution of the search strings through a graphical user interface search window. In a preferred embodiment of the invention, in response to the user selection of a portion of the text in a document, the system presents a set of keywords for the user in a user interface box or in a drop down menu which allows the user to select/deselect the keywords of his interest to modify the keywords set. After modifying the keywords set, the user can initiate an action to locate the most relevant paragraph based on these modified/selected keywords. The inventive system automatically ranks a plurality of the paragraphs/portion of paragraphs based on the relevancy of the user selected keywords sets.

This patent application claims the priority under 35 USC 119 (e) of provisional patent application Ser. No. 61/367,453 filed on Jul. 26, 2010 and 61/366,937 filed on Jul. 23, 2010.

### FIELD OF THE INVENTION

The present invention generally relates to text-based data searching and analysis and, more particularly, to methods, systems, and program products for advanced searching and analysis.

### BACKGROUND OF THE INVENTION

Several search engines are developed that are geared toward locating relevant patent documents for a researcher. After location of a patent document, the user still needs to go through the various sections of the document to find the relevant content. Location of the relevant content in a document by means of user selected keyword is not sufficient, when the searcher needs to thoroughly evaluate a patent in a short time. The research process can be enhanced, if there is provided a method to quickly locate various portions of the document having similar content in a given patent document.

A large amount of data is generally available for search and retrieval by a search engine, including files and text data residing upon local computers or devices, local area networks (LAN), wide area network (WAN), and interne and intranet networked computer resources and their associated storage devices. Search engines have been developed which can retrieve a good number or relevant data to the researcher. Providing a data set that includes most relevant data set is a big challenge. To minimize the risk of losing the most relevant data set researchers use user a good and broad enough keywords/strategy and gather a good number of references and analyze them. Analyzing thoroughly a large number of references a in a limited time, particularly when there are multiple search features, is challenge that has not been addressed so far. A solution that address above problem will definitely enhance the quality and thoroughness of a researcher for analyzing a large number of larger sized documents/references.

### SUMMARY OF THE INVENTION

Methods, programs products and systems are provided for improved techniques for enabling a search engine user to quickly and effectively analyze a patent and non-patent document by analyzing the user's inputted query and presenting a plurality of keyword set to the user which can be used to analyze the result in more focused and efficient way.

The methods comprise a programmable device search engine component searching a database for textual information relevant to a search term and retrieving search results text items; presenting retrieved search results text items to a user on a display device through a graphical user; selecting at least a portion of text through a cursor, automatically locating keywords from the selected portion of the text and presenting the keywords to the user for addition or removal of the keywords; and user initiating an action such as clicking an interface button, and presenting the user the most relevant portions of the document and providing a ranking for the presented portion of the text.

According to one of the preferred embodiments, the inventive program code of the system automatically categorizes the user's search strings (having multiple strings representative of multiple features) and displays multiple keyword sets wherein each keyword set represents the individual features after the execution of the search strings through the GUI search window. A user can select one or plurality of Keyword Sets Buttons to highlight through the on user selection of a keyword set (s).

In another preferred embodiment, a user can select one or plurality of Keyword Sets Buttons, and in response to this, the inventive system will automatically present the user the most relevant portions of the document and provide a ranking for the presented portion of the text.

According to another preferred embodiment, the user can simply copy/paste the search features in a form of a sentence or a paragraph in a GUI search box, and the system program code will automatically analyze and parse the keywords and generate the keyword sets. Once the keywords sets are generated, the system allows the user to open each keyword sets and input the new keywords he wants to input or modify the set. He can add another keyword set to represent another feature etc. A user is provided a mechanism to select/deselect one or more keyword sets to change a color scheme in the current document /patent opened. In response to a user selecting a keyword set, the system will automatically display the current/selected keyword string.

According to another preferred embodiment, upon opening the search result, the system will automatically present a list of additional keywords. A user can open a particular keyword set to populate its plurality of keywords spectrum and synonyms by clicking a Keyword Set Button (for example) and drag and drop the system presented keyword into the spectrum of the keyword set. A user can select one or plurality of Keyword Sets Buttons, and in response to this, the inventive system will automatically present the user the most relevant portions of the document and provide a ranking for the presented portion of the text.

According to another preferred embodiment, the system allows a user to select a portion of the text in the document and the inventive system will automatically rank a plurality of the paragraphs/portion of paragraphs based on the relevancy of the user selected text. In another embodiment, in response to user selecting/highlighting a portion of the text, the system will automatically bring the most relevant paragraph to the user's view with most relevant keywords highlighted with an automatically selected color or a user selected color scheme.

In further preferred embodiment of the invention, in response to the user selection of a portion of the text, the system will populate a set of keywords for the user in a new box or in a drop down menu which allows the user to select/deselect the keywords of his interest. After selecting the keywords, the user can initiate an action to locate the most relevant paragraph based on these keywords. The inventive system will automatically rank a plurality of the paragraphs/portion of paragraphs based on the relevancy of the user selected keywords.

### BRIEF DESCRIPTION OF THE DRAWINGS

These and other features of this invention are illustrated from the following detailed description of the various aspects of the invention taken in conjunction with the accompanying drawings in which:

FIG. 1 describes GUI layout of keyword sets and highlighted part of the paragraph based on user selection of a keyword set. The keyword strings corresponding to the selected keyword set are displayed at the top of the layout.

FIGS. 2 and 3 describe similar scenarios as in FIG. 1 wherein the user is switching to new keywords set. User can easily switch to new keyword set by clicking a button.

FIG. 4 describes similar scenario as in FIG. 1 with paragraphs having minimize buttons. FIG. 4 also displays additional keywords extracted/detected by the system. The user can select these keywords set for highlighting purpose or can send to one of the categorized keyword set which are representative of a particular feature of the search.

FIG. 5 describes a GUI layout wherein a user can mouse select a text word (keyword) and upon the selection, a drop down menu will appear which will let the user to send the selected keyword into the keyword highlighting box or allows the user to directly highlight the keyword in the whole document.

FIG. 6 shows a GUI layout wherein the user selected keywords and detected keywords are separately presented in different boxes for user convenience.

FIG. 7 describes a similar GUI layout wherein a Keyword set (representative of a feature) has been expanded to show the color spectrum of the keywords (and synonyms). A user can add new keyword or save as new keyword set as needed.

FIG. 8 describes a GUI layout wherein a user selects a Similarity Excitation Button adjacent to a paragraph which leads to highlighting of the relevant paragraphs in a user selected color scheme. In another embodiment, the paragraphs can be ranked for relevancy.

FIG. 9 describes another similar GUI layout as in FIG. 8 with additional Similarity Excitation Button. A user can use the Similarity Excitation Button or select a portion of the text in the document to automatically locate the most relevant paragraph/portion of the text.

FIGS. 10-12 describes similar GUI layout wherein in response to a user selection of a paragraph (or a user selection of a portion of a text) the program code of the inventive system can locate most relevant paragraph (to the selected portion of the text). The GUI also allows to automatically sending the detected keywords in the highlighting box.

FIG. 13 describes a GUI layout, where in response to the user selection of a portion of the text, the system will present a set of keywords for the user in a new box or in a drop down menu which allows the user to select/deselect the keywords of his interest. After selecting the keywords, the user can initiate an action to locate the most relevant paragraph based on these keywords.

FIG. 14 describes GUI layout wherein in response to a user selection of a paragraph (or a user selection of a portion of a text) the program code of the inventive system can locate most relevant paragraph (to the selected portion of the text). Other layouts are hidden.

FIG. 15, describes a computerized implementation of the invention according to an embodiment of the invention.

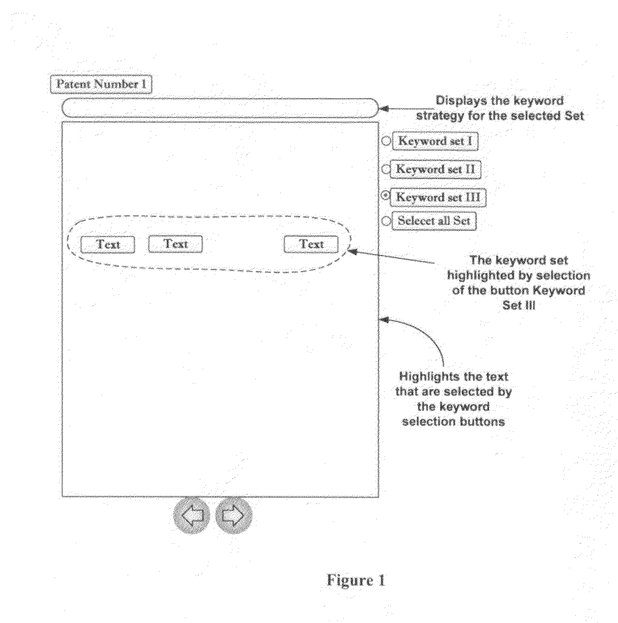

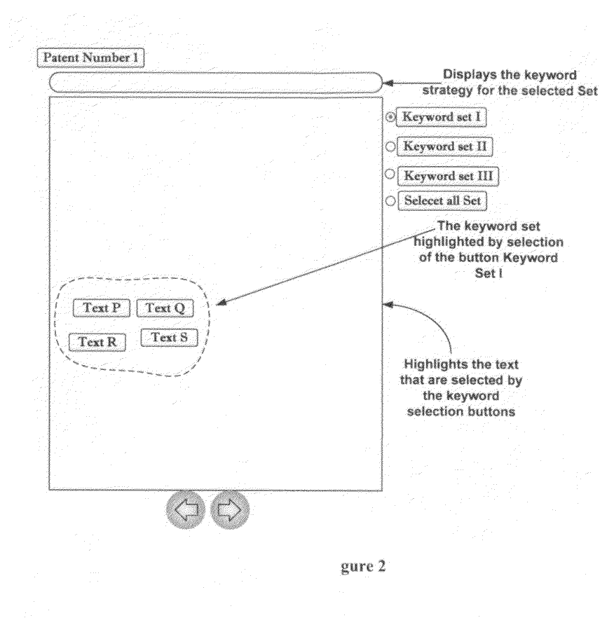

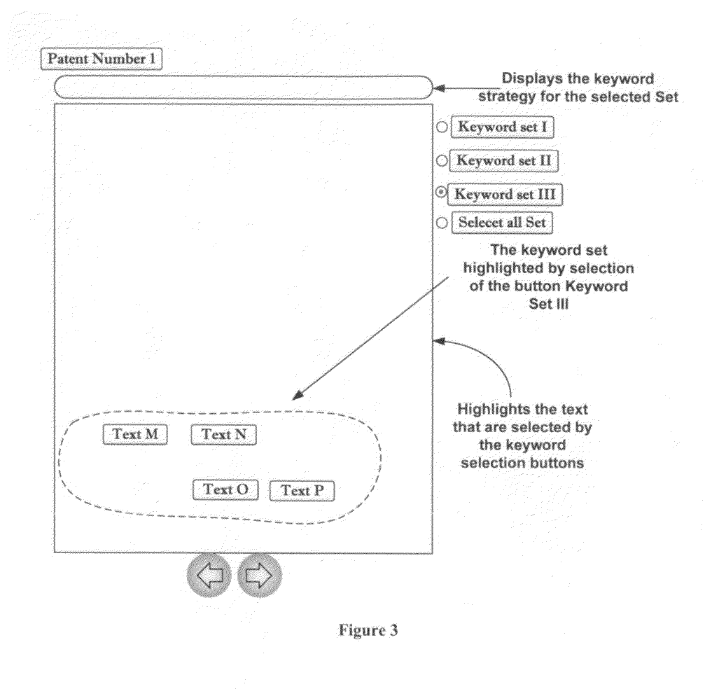

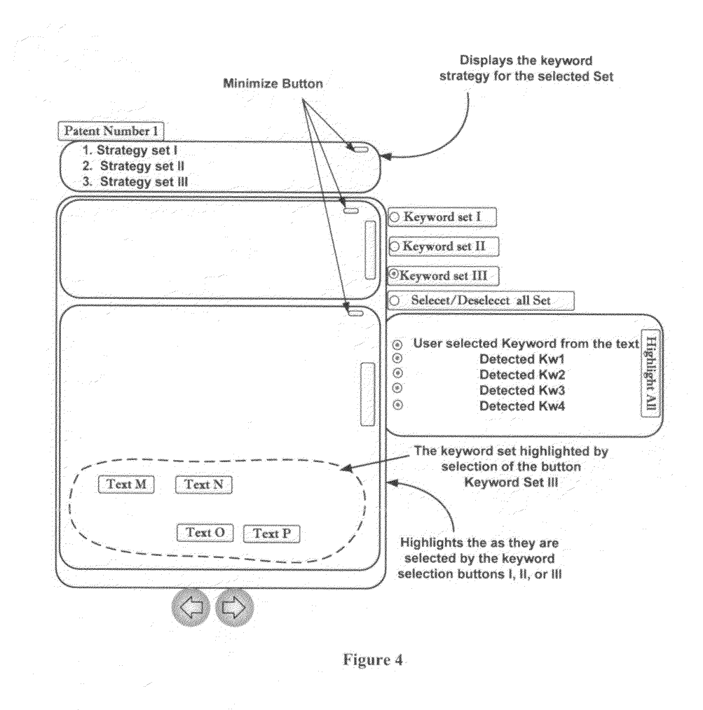

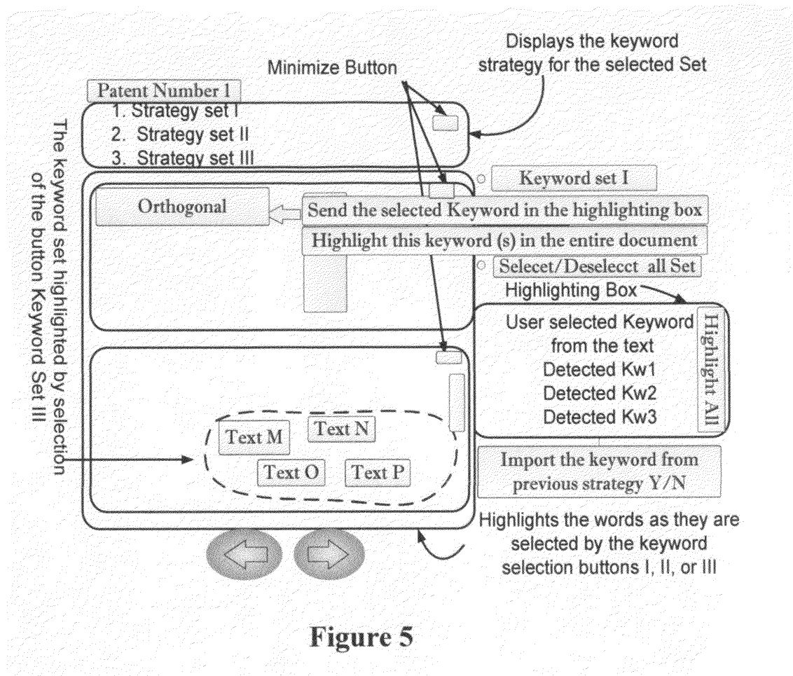

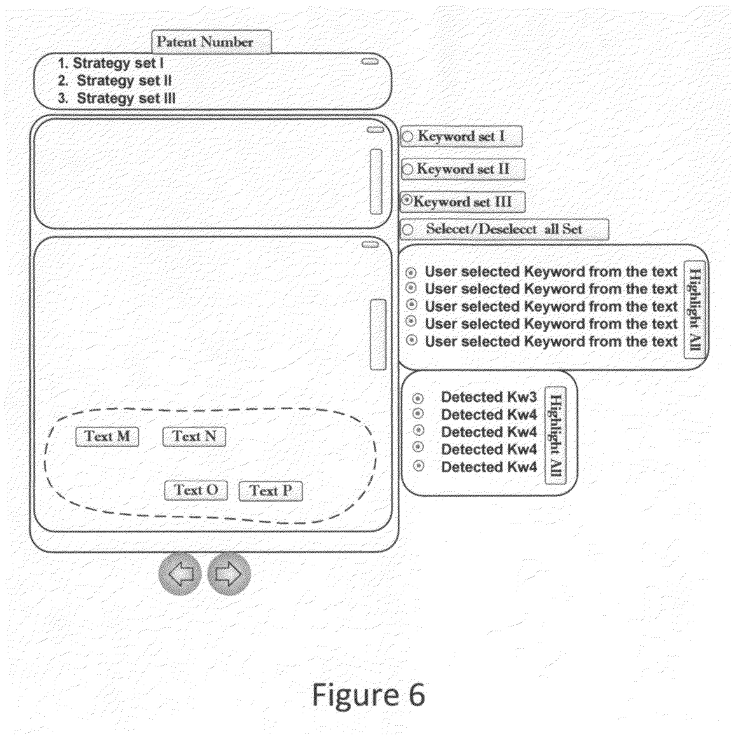

The drawings are not necessarily to scale. The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE INVENTION

A user inputs a search string in GUI of a search engine. The search results are presented to a user in the form of a list in order of likely relevancy. Each item may comprise one or more of a text hyper-linking to a storage device file location or an internet webpage comprising the result.

A search engine searches at least one database (illustratively including local computer device storage media, external storage media accessible through network communications, and the internet) and retrieves a plurality of results from an initial search term entered by a user.

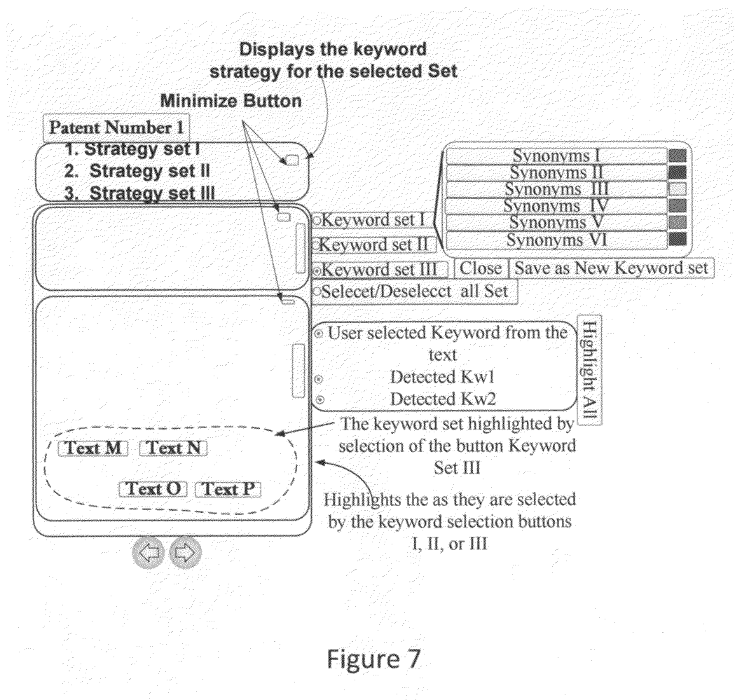

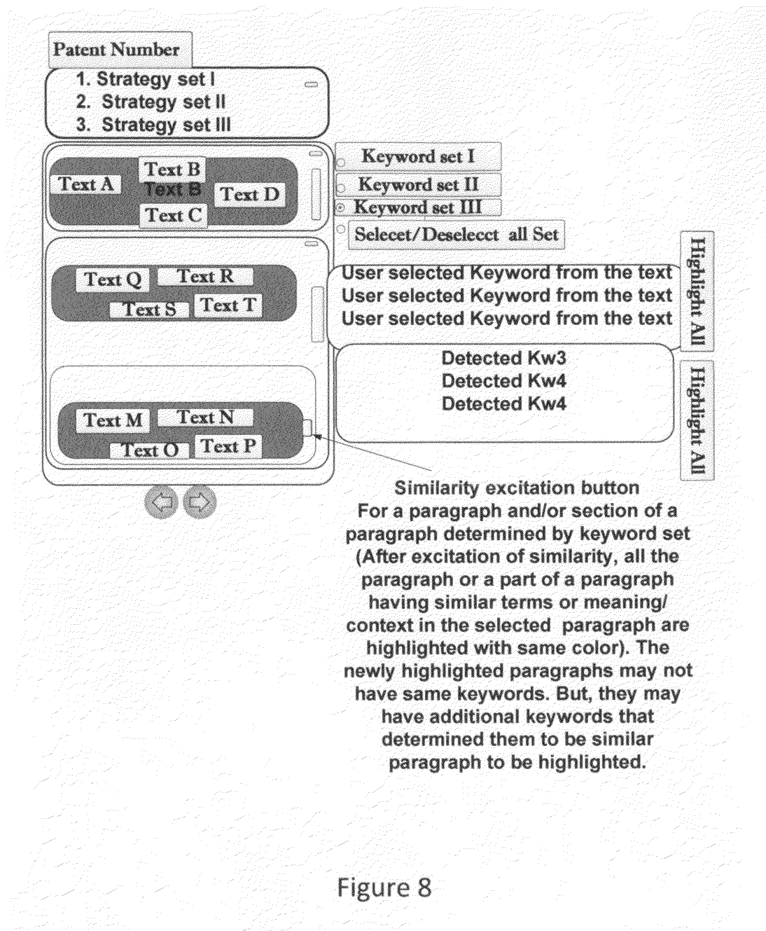

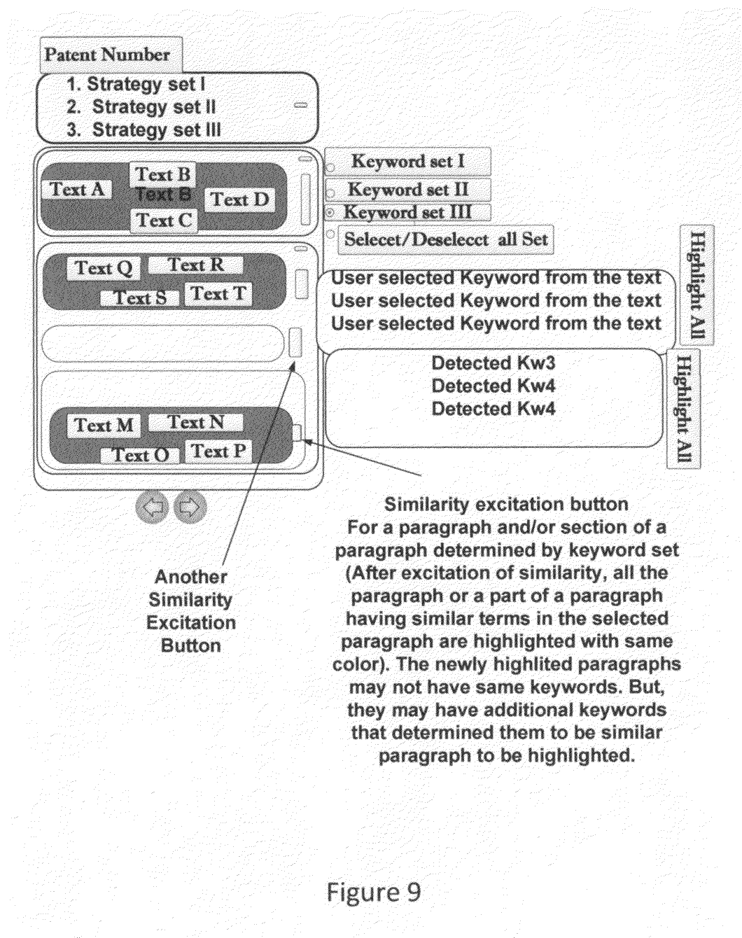

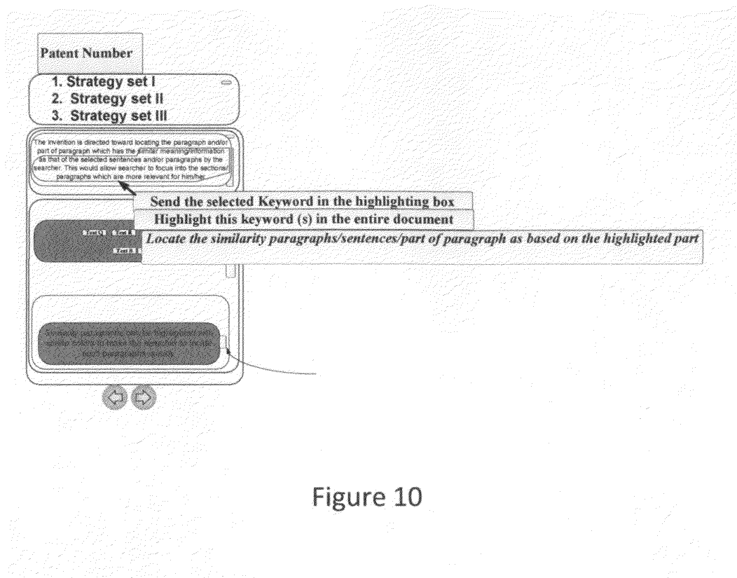

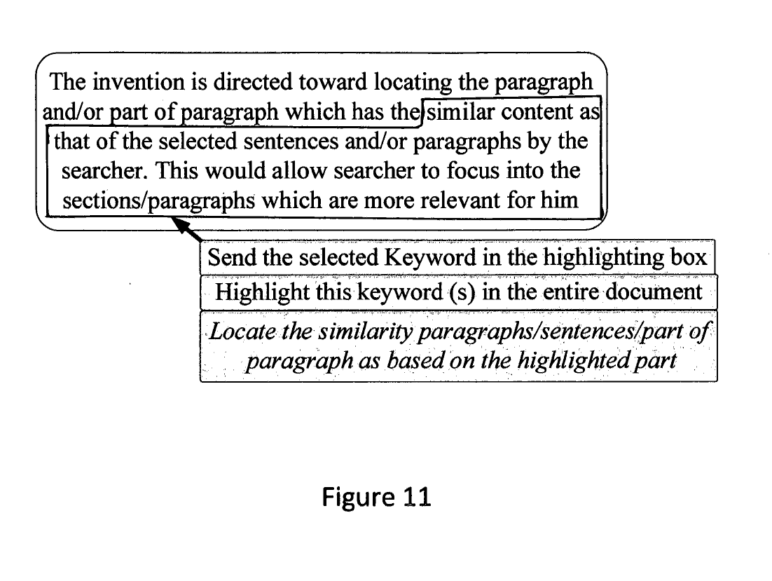

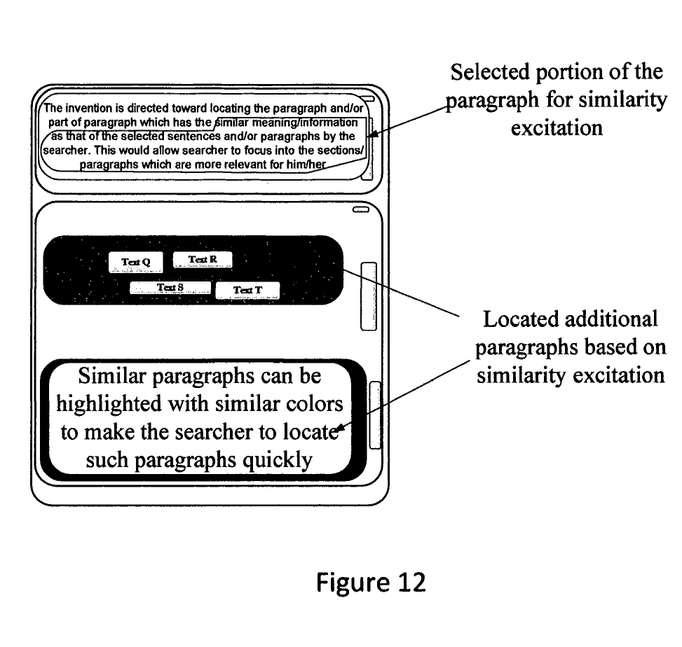

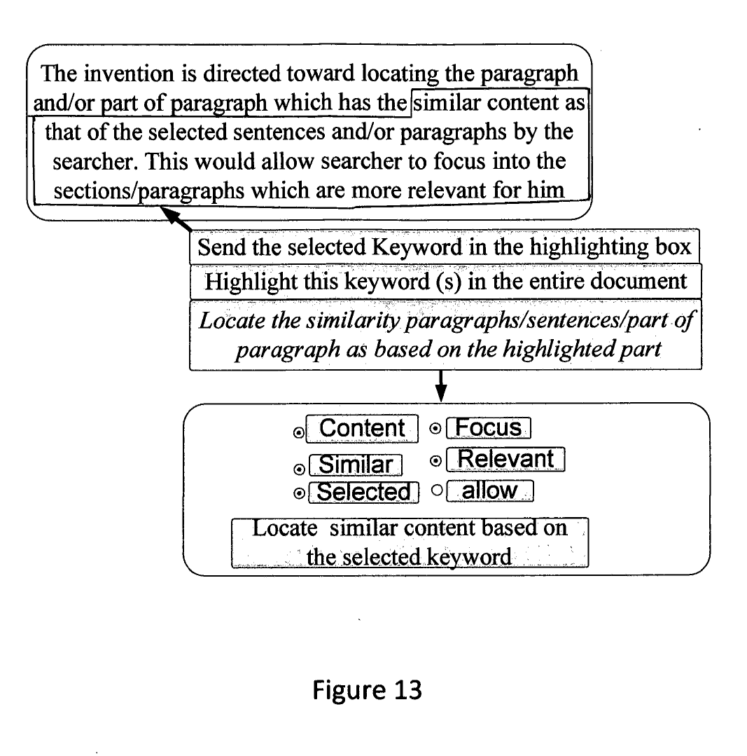

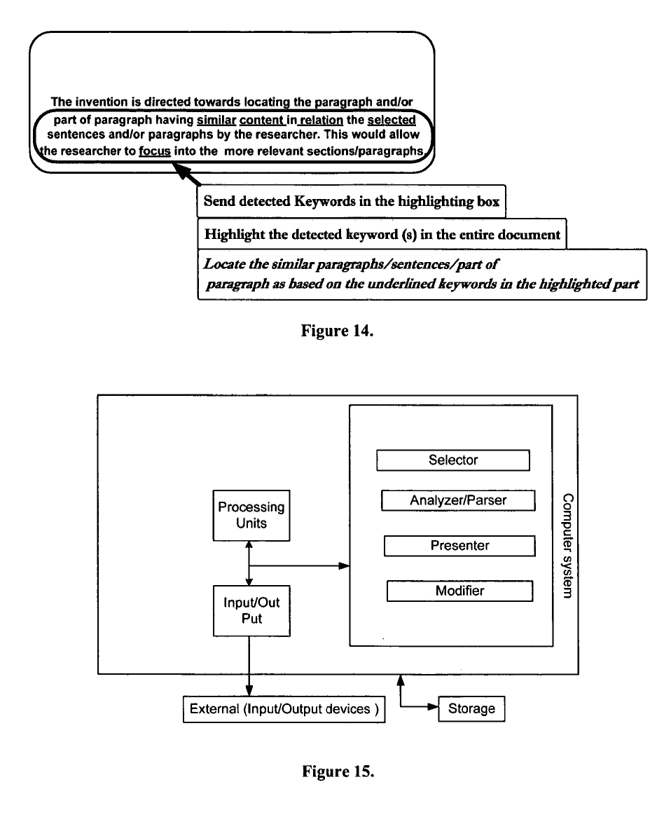

According to one of the preferred embodiments (Described in FIG. 7), the inventive system automatically categorizes the user's search strings (having multiple strings representative of multiple features) and displays multiple keyword sets wherein each keyword set represents the individual features after the execution of the search strings through the GUI search window.

Let's consider a searcher is searching for a wireless device that can detect a driver's vehicle speed and sends the speed value to a central location where it is monitored, and a warning signal is sent back to the driver. His search features are represented by the following keyword sets with proximity relation as needed.

Set I: (wireless or mobile or cellular or phone)
Set II: (detect or sense or read) <proximity operator> (velocity or speed)
Set III: (send or transfer or transmit) <proximity operator> (remote or central or distant) <proximity operator> (monitor or inspect or examine)
Set IV: (warn or alarm) <proximity operator> (driver or operator)
The searchers final search string that covers all the features that he is looking for is
set I <and> set II <and> set III <and> set IV; or, it could be any other combination of set I, set II, set III and set IV.

In response to inputting and executing the above string, the program code of the system provides a list of relevant results in the order of relevance to the user. When the user selects a result to view the text of the result, the program code of the system automatically parse and analyze this final string based on keywords and their proximity relationship with other keywords and synonyms of the search string and compares these keywords with the located keywords and synonyms in the selected result, and presents an interface as described in FIG. 7 wherein plurality of keywords set interface are displayed and wherein each keyword set represents the individual feature. The program code of the system transforms the keywords of the search into categories (based on the features) which is extremely important for the users to analyze the patent efficiently. Each keyword set incorporates keywords (and synonyms) and proximal keywords. For each keywords set, the synonyms will be highlighted with the same color and proximal keywords will be highlighted with a different color scheme.

According to another preferred embodiment, the user is capable of simply copy/paste the search (In the exemplary above the user inputs the text “wireless device that can detect a driver's vehicle speed and sends the speed value to a central location where it is monitored, and a warning signal is sent back to the driver”.) features in his GUI search box, and the system program code automatically present the search result in the order of relevancy. In response to a user selecting a result, the program code of the system analyze and parse the keywords and generate the keyword sets described above and presents the keywords sets as described in the above embodiment.

Once the keywords sets are generated, the system allows the user to open each keyword sets and input the new keywords he wants to input or modify the set. He can add another keyword set to represent another feature etc.

A user can select/deselect one or more keyword sets to change a color scheme in the current result/document/patent opened.

In response to a user selecting a keyword set, the system will automatically display the current/selected keyword string as described in FIG. 7.

According to another preferred embodiment, upon opening the search result, the system automatically present a list of additional keywords. A user can open a particular keyword set to populate its plurality of keywords spectrum and synonyms by clicking a Keyword Set Button (for example) and drag and drop the system presented keyword into the spectrum of the keyword set.

According to another preferred embodiment, the system allows a user to select a portion of the text in the document and the inventive system will automatically rank a plurality of the paragraphs/portion of paragraphs based on the relevancy of the user selected text. In another embodiment, in response to user selecting/highlighting a portion of the text, the system will automatically bring the most relevant paragraph to the user's view with most relevant keywords highlighted with an automatically selected color or a user selected color scheme.

In further preferred embodiment of the invention, in response to the user selection of a portion of the text, the system will populate a set of keywords for the user in a new box or in a drop down menu which allows the user to select/deselect the keywords of his interest. After selecting the keywords, the user can initiate an action to locate the most relevant paragraph based on these keywords.

The program code and hardware can be generated by using standard programming and engineering techniques. The implementation can be made in cluster of processing units, single processing unit, or in client server type environment. The system includes computer system including processing unit, memory, storage system, I/O interfaces, storage system etc.

The processing unit executes computer program code to implement the multiple steps/components of the process including searching, ranking of the results, analyzing/parsing of the inputted strings, generating keywords sets in relation with the inputted strings and available keywords and frequency of the keywords in the selected result, utilizing the frequency relationship among the keywords, displaying the graphical user interface for the keywords set, highlighting the keywords in accordance with the color scheme of the selected keywords etc.

In executing the program code, the processing unit reads and/or writes data from the memory, storage system and or from the interfaces. A bus is provided for developing a communication link between each of the components in the computer system. The external device that can communicate with the user include keyboard, pointing device, display, etc. to enable user to communicate with the computer system.

The description of various aspects of the invention has been presented for purposes of illustration and description only. It is not intended to limit the inventive methods/system to the precise form disclosed. Several modifications, variations and implementation are possible which may be apparent to the ordinal skill in the art.

We claim:

1. A method for search terms generation and categorization and search enhancement:
receiving a search request from an end user, the search request including a plurality of keywords and/or combination of keywords representing multiple search features;
displaying the relevant results to the user;
upon selection of a result, displaying together with the text of the result, a plurality of user interfaces wherein each user interface represents a set of keywords; and wherein each user interface is capable of displaying the set of keywords upon a user action to the user interface, wherein each set of keyword is a representative of a search feature;
allowing the user to select a user interface by performing an action to the user interface, the action including clicking the user interface; and
in response to the user selection of the interface, highlighting the keywords of the search result in accordance with the said selected interface and keywords represented by that interface.

2. The method of claim 1, wherein upon the selection of the said one or more user interfaces presenting only the most relevant portion of the text of the selected result to the user in accordance to the keywords represented by that interface.

3. The method of claim 1, wherein upon selection of the said one or more interfaces determining the relevancy of the paragraphs of the in accordance with the keywords represented by that interface and presenting the relevant paragraphs of a selected result in the order of relevancy.

4. The method of claim 1, wherein the search request is received in form of paragraph(s) or portion of a paragraph or a sentence, or a part of sentence or a phrase.

5. The method of claim 1, wherein the received search request includes a plurality of keywords or combination of keywords with operators defining the proximity between the keywords for representing multiple search features.

6. The method of claim 1, wherein the said user interfaces are capable of displaying a user modifiable additional plurality of spectrum of user interfaces in response to the user selection of the said user interface and wherein the keywords are saved in the spectrum of interfaces according to their similarity/synonyms and proximal/proximity relationship with other keywords, and wherein a user can modify said user interfaces by adding new keywords or removing keywords.

7. The method of claim 6, wherein a color scheme is provided for highlighting the keywords in the said user interface wherein the user can select the highlighting color scheme according to his choice.

8. The method of claim 1, wherein a user can add or delete said user interfaces for inputting a set of keywords or removing a set of keywords representing a search feature.

9. The method of claim 1, wherein the number of displayed said user interfaces is based on the matching keywords/synonyms or frequency of matching keywords/synonyms and proximity relationship among them in displayed specific search result.

10. The method of claim 1, wherein the system automatically presents a list of additional keywords, and upon a user action, the keywords can be included into said keyword set or into the set of keywords represented by said user interface.

11. A method for search terms generation, categorization and search enhancement:
receiving a search request from an end user, the search request including plurality of keywords and/or combination of keywords with proximity and similarity relationship among the keywords representing multiple search features;
displaying search results, the result including a list of relevant document/result to the user;
upon selection of a result/document, parsing and analyzing the content in the selected document and displaying together with the result/document,
a first list of keywords used by the user wherein the first list of keywords is a representative of a first search feature of the search wherein the first list of keywords are GUI enabled for being selectable or deselectable;
a second list of keywords used by the user wherein the second list of keywords is a representative of the second search feature of the search wherein the second list of keywords are GUI enabled for being selectable or deselectable;
displaying the said list of the keywords in accordance with the proximity and similarity relationship with each other and in accordance with the search feature;
providing another user interface means to adjust the proximity (proximal) relationship among the keywords and synonyms of the first and second list of keywords so that in response to a user action with the said another interface, the keywords highlighting scheme modifies;
highlighting the keywords of the selected search result in accordance the modified highlighting scheme.

12. The method of claim 11, wherein upon adjustment of the proximity (proximal) relationship among the keywords and synonyms of the said first and said second list of keywords in response to a user action with the said another interface, presenting only the most relevant portion of the text to the user in accordance with the modified highlighting scheme.

13. The method of claim 11, wherein upon adjustment of the proximity (proximal) relationship among the keywords and synonyms of the said first and said second list of keywords in response to a user action with the said another interface, determining the relevancy of the paragraphs of in accordance with the keywords and presenting the relevant paragraphs of a selected result in the order of relevancy.

14. The method of claim 11, wherein the search request is received in the form of paragraph(s) or portion of a paragraph or a sentence, or a part of sentence or a phrase.

15. The method of claim 11, wherein the received search request includes a plurality of keywords combination with operators defining the proximity relationship between the keywords for multiple search features.

16. The method of claim 11, wherein a color scheme is provided for highlighting the keywords in the said user interface wherein the user can select the highlighting color scheme according to his choice.

17. A method for search terms generation, categorization and relevant text location in a search result;
receiving a search request from an end user, the search request including plurality of keywords and/or combination of keywords representing multiple search features;
displaying a result in the order of relevancy including a list of patent/non-patent document,
allowing a user to select a first portion of the text in patent/non-patent literature document resulted from the search, and in response to the user selection of the first portion, automatically highlighting a second portion of the patent/non-patent literature in the same patent/non-patent literature wherein the first portion and the second portion have closest similar contents compared to the rest of the patent/ non-patent literature.

18. The method of claim 17, wherein in response to the user selection of a portion of the text, the system presents a set of keywords in a user interface box or in a drop down menu which allows the user to select/deselect the keywords of his interest to modify the set of keywords, and in response to the user modifying the set of keywords and the user's initiation of an action to locate the most relevant paragraph based on the modified keywords set, locating the most relevant paragraph in the patent/non-patent document result, and displaying the most relevant paragraph to the user with a user selected highlighting scheme.

19. The method of claim 18, wherein in response to the user selecting the keywords and the user's initiation of an action to locate the most relevant paragraph based on the modified keywords set, determining the relevancy of the paragraphs in accordance with the modified keywords and presenting the relevant paragraphs in the order of relevancy.

20. The method of claim 17, wherein in response to a user selection a first portion of the text in patent/non-patent literature document resulted from the search, displaying a set of graphical user interfaces wherein, each graphical user interfaces displays a set of keywords upon selection and wherein each graphical user interface is representative of a feature of the search represented by the keyword set.
